(19) United States
(12) Patent Application Publication
(10) Pub. No.: US 2025/0321930 A1
(43) Pub. Date: Oct. 16, 2025

(54) TECHNIQUES FOR OPTIMIZING PROJECT DATA STORAGE

(71) Applicant: Northspyre, Inc., Brooklyn, NY (US)

(72) Inventors: William Sankey, Atlanta, GA (US); Matthew Phinney, Brooklyn, NY (US)

(21) Appl. No.: 18/636,710

(22) Filed: Apr. 16, 2024

(51) Int. Cl. G06F 16/16; G06F 16/11; G06F 16/25; G06N 5/022

(52) U.S. Cl. CPC G06F 16/16; G06F 16/116; G06F 16/254; G06N 5/022

(57) ABSTRACT

Techniques for optimizing project data storage are disclosed. An example system includes processors and memories communicatively coupled with the processors storing a trained machine learning (ML) model, a data inbox, a project database associated with a project, and instructions that cause the processors to: receive, at the data inbox, an input including data corresponding to the project, wherein the data is formatted in accordance with a non-standardized format; execute the trained ML model to: extract the data from the input, and analyze the data to output (i) a predicted classification and (ii) a predicted impact associated with the project; convert the data to a standardized format based on the predicted classification; store (i) the data and (ii) the predicted impact in the project database; and generate an indication of the data and the predicted impact for display to a user as part of the data inbox.

### FIELD OF THE DISCLOSURE

The present disclosure generally relates to optimizing data storage, and more particularly, to techniques for optimizing project data storage by leveraging trained machine learning (ML) models to determine predicted classifications of data received at a data inbox in a non-standardized format and converting/storing the data in a standardized format based on the predicted classifications.

### BACKGROUND

Organizing data and optimizing data storage are concepts of great interest across a wide variety of industries, particularly those industries where receiving and storing data from a diverse set of entities is commonplace. The commercial real estate (CRE) industry, for example, typically involves a single entity (e.g., project management) receiving and storing data from a large number of distinct entities (e.g., contractors, subcontractors, etc.). In many cases, these distinct entities use a myriad of platforms and/or non-standardized data formats to track the various commitments for a particular project.

However, such non-standardized data formats can be highly specific and used to track granular level project commitments, and conventional project management techniques struggle to accurately extract, classify, communicate, and store the data at least partially due to these highly variable formats. When received data is misclassified, that misclassified data skews metrics/values associated with the project, which can result in wasting additional time and resources to resolve the misclassification(s). Thus, conventional techniques frequently fail to extract data received in a non-standardized format and/or misclassify any extracted data, leading to erroneous data entry and correspondingly incorrect and misleading project metrics/values.

Accordingly, there is a need for techniques to optimize project data storage in a manner that alleviates or eliminates these issues conventional techniques experience.

### SUMMARY

In some aspects, the techniques described herein relate to a system for optimizing project data storage including: one or more processors; and one or more memories communicatively coupled with the one or more processors, the one or more memories storing a trained machine learning (ML) model, a data inbox, a project database associated with a project, and computer executable instructions that, when executed by the one or more processors, cause the one or more processors to: receive, at the data inbox, an input including data corresponding to the project, wherein the data is formatted in accordance with a non-standardized format; execute the trained ML model to: extract the data from the input, and analyze the data to output (i) a predicted classification and (ii) a predicted impact associated with the project; convert the data to a standardized format based on the predicted classification; store (i) the data and (ii) the predicted impact in the project database; and generate an indication of the data and the predicted impact for display to a user as part of the data inbox.

In some aspects, the techniques described herein relate to a system, wherein the trained ML model is trained using a plurality of training inputs and a plurality of training extracted data as input to output a plurality of training predicted classifications and a plurality of training predicted impacts.

In some aspects, the techniques described herein relate to a system, wherein the data included in the input is a subset of a plurality of data included in the input, and the computer executable instructions, when executed by the one or more processors, cause the one or more processors to execute the trained ML model to: analyze the plurality of data included in the input to determine that a remainder of the plurality of data is redundant data that is stored as part of the project; and extract the subset from the input without extracting the remainder of the plurality of the data.

In some aspects, the techniques described herein relate to a system, wherein the project database includes a plurality of standardized data, and the computer executable instructions, when executed by the one or more processors, further cause the one or more processors to: determine that a report threshold is exceeded based on the data included in the input; automatically generate a report associated with the project based on the data included in the input and at least a portion of the plurality of standardized data; and generate an indication of the report for display to the user as part of the data inbox.

In some aspects, the techniques described herein relate to a system, wherein the trained ML model utilizes at least one of: (i) optical character recognition (OCR), (ii) image recognition, (iii) object recognition, or (iv) image extrapolation.

In some aspects, the techniques described herein relate to a system, wherein the indication includes a reference link to the input.

In some aspects, the techniques described herein relate to a system, wherein the computer executable instructions, when executed by the one or more processors, further cause the one or more processors to: transmit a message for users connected to the data inbox in real-time indicating the data and the predicted impact.

In some aspects, the techniques described herein relate to a system, wherein the predicted classification indicates a data type associated with the data, and the predicted impact indicates one or more effects caused by the data to other data stored as part of the project.

In some aspects, the techniques described herein relate to a system, wherein the computer executable instructions, when executed by the one or more processors, cause the one or more processors to convert the data to a standardized format by: determining one or more data input locations within a file associated with each individual data value from the data based on the data type indicated by the predicted classification, wherein the file is stored within a relational database; and inputting the individual data values into the one or more data input locations.

In some aspects, the techniques described herein relate to a system, wherein the computer executable instructions, when executed by the one or more processors, further cause the one or more processors to: identify an inconsistency within the data based on other data stored in association with the project; and generate an alert for transmission to an entity that transmitted the data to the data inbox indicating the inconsistency.

In some aspects, the techniques described herein relate to a system, wherein the trained ML model is a first trained ML model, and the computer executable instructions, when executed by the one or more processors, further cause the one or more processors to: determine a first data category for the data included in the input; execute a second trained ML model to determine a predicted data category mapping for the first data category that maps the first data category to a normalized data category, wherein the trained ML model is trained using a plurality of training data categories and a plurality of training normalized data categories as input to output a plurality of training predicted data category mappings; execute, based on the predicted data category mapping, a nesting data module configured to: input the first data category into a first table having a first file size, and collapse the first table with a second table that includes a second data category that is related to the first data category to generate a nested table, wherein the second table has a second file size, and the nested table has a third file size that is less than a combination of the first file size and the second file size; and store the nested table in the project database.

In some aspects, the techniques described herein relate to a system, wherein the input is a first input, the data is a first set of data, the non-standardized format is a first non-standardized format, the predicted classification is a first predicted classification, the predicted impact is a first predicted impact, the indication is a first indication, and the computer executable instructions, when executed by the one or more processors, further cause the one or more processors to, in parallel with the first input by utilizing parallel processing: receive, at the data inbox, a second input including a second set of data corresponding to the project, wherein the second set of data is formatted in accordance with a second non-standardized format; execute, the trained ML model to: extract the second set of data from the second input, and analyze the second set of data to output (i) a second predicted classification and (ii) a second predicted impact associated with the project; convert the second set of data to the standardized format based on the second predicted classification; store (i) the second set of data and (ii) the second predicted impact in the project database; and generate a second indication of the second set of data and the second predicted impact for display to the user as part of the data inbox.

In some aspects, the techniques described herein relate to a system, wherein the data inbox accesses received inputs via a listener interface configured to automatically retrieve and process the received inputs in real-time.

In some aspects, the techniques described herein relate to a computer-implemented method for optimizing project data storage including: receiving, at a data inbox indicating project data corresponding to a project, an input including data corresponding to the project, wherein the data is formatted in accordance with a non-standardized format; executing, by one or more processors, a trained machine learning (ML) model to: extract the data from the input, and analyze the data to output (i) a predicted classification and (ii) a predicted impact associated with the project; converting, by the one or more processors, the data to a standardized format based on the predicted classification; storing, by the one or more processors, (i) the data and (ii) the predicted impact in a project database associated with the project; and generating, by the one or more processors, an indication of the data and the predicted impact for display to a user as part of the data inbox.

In some aspects, the techniques described herein relate to a computer-implemented method, wherein the trained ML model is trained using a plurality of training inputs and a plurality of training extracted data as input to output a plurality of training predicted classifications and a plurality of training predicted impacts.

In some aspects, the techniques described herein relate to a computer-implemented method, wherein the data included in the input is a subset of a plurality of data included in the input, and the method includes executing the trained ML model to: analyze the plurality of data included in the input to determine that a remainder of the plurality of data is redundant data that is stored as part of the project; and extract the subset from the input without extracting the remainder of the plurality of the data.

In some aspects, the techniques described herein relate to a computer-implemented method, wherein the project database includes a plurality of standardized data, and the method further includes: determining, by the one or more processors, that a report threshold is exceeded based on the data included in the input; automatically generating, by the one or more processors, a report associated with the project based on the data included in the input and at least a portion of the plurality of standardized data; and generating, by the one or more processors, an indication of the report for display to the user as part of the data inbox.

In some aspects, the techniques described herein relate to a computer-implemented method, wherein the predicted classification indicates a data type associated with the data, and the predicted impact indicates one or more effects caused by the data to other data stored as part of the project.

In some aspects, the techniques described herein relate to a computer-implemented method, wherein converting the data to a standardized format includes: determining, by the one or more processors, one or more data input locations within a file associated with each individual data value from the data based on the data type indicated by the predicted classification, wherein the file is stored within a relational database; and inputting, by the one or more processors, the individual data values into the one or more data input locations.

In some aspects, the techniques described herein relate to a tangible machine-readable medium including instructions that, when executed, cause a machine to at least: receive, at a data inbox indicating project data corresponding to a project, an input including data corresponding to the project, wherein the data is formatted in accordance with a non-standardized format; execute a trained machine learning (ML) model to: extract the data from the input, and analyze the data to output (i) a predicted classification and (ii) a predicted impact associated with the project; convert the data to a standardized format based on the predicted classification; store (i) the data and (ii) the predicted impact in a project database associated with the project; and generate an indication of the data and the predicted impact for display to a user as part of the data inbox.

As mentioned, conventional project data storage techniques struggle to accurately extract, classify, communicate, and store data at least partially due to the highly variable formats utilized by entities transmitting the data. The techniques of the present disclosure overcome these issues by (1) extracting and analyzing non-standardized data received at a data inbox with a trained machine learning model that outputs a predicted classification, (2) converting the data to a standardized format based on the predicted classification, (3) storing the data in a project database, and (4) generating an indication of the data as part of the data inbox. In other words, the techniques provide remote access over a network, convert newly received project data input by a remote user in a non-standardized form to a standardized format, store the standardized data, and generate an indication of the data for display to a user. Consequently, the techniques of the present disclosure improve over conventional project data storage techniques at least by allowing remote users to share information (e.g., with project management) in real-time and in a standardized format regardless of the format in which the information was input by the remote user, which conventional techniques were unable to accomplish/provide.

Further, in accordance with the above, and with the disclosure herein, the present disclosure includes improvements in computer functionality or in improvements to other technologies at least because the disclosure describes that, e.g., a hosting server or otherwise computing device (e.g., a user computing device), is improved where the intelligence or predictive ability of the hosting server or computing device is enhanced by a trained machine learning model. This model, executing on the hosting server or computing device, is able to accurately and efficiently extract non-standardized data and output a predicted classification and impact of the data. Using these outputs of the machine learning model, the techniques of the present disclosure then convert the data to a standardized format, store the data in the standardized format, and generate an indication of the data and predicted impact for display to a user.

That is, the present disclosure describes improvements in the functioning of the computer itself or “any other technology or technical field” because a hosting server or computing device, is enhanced with a trained machine learning model. The trained machine learning model accurately extracts data and predicts classifications and impacts of the data that optimize project data storage by increasing the accuracy and efficiency of such storage. Namely, the trained machine learning model predicting classifications and impacts of the data reduces/eliminates the time and resources required to correct erroneous data classification and metric impacts suffered by conventional techniques. The trained machine learning model therefore improves over the prior art at least because existing systems lack such extracting and/or predictive functionality and are generally unable to analyze such non-standardized data to output predictive classifications and/or otherwise recommended standardized formats designed to optimize project data storage.

Additionally, the techniques of the present disclosure improve the functioning of a computer by providing a nesting data module. The nesting data module is configured to further optimize the project data storage capacity requirements through creation of nested data tables. In particular, the nesting data module may generate a nested table by collapsing a first table including a first data category with a second table that includes a second data category that is related to the first data category. Each of the first table and the second table have a corresponding file size, and the nested table has a file size that is less than a combination of the file sizes of the first table and the second table. Thus, storing the nested table instead of the first table and the second table individually conserves storage resources by requiring less storage capacity to store the same data. Accordingly, the techniques of the present disclosure improve the functioning of a computer, as compared to conventional techniques, at least because such conventional techniques lack the nesting data module or similar functionality, and correspondingly require more data storage capacity/memory resources than the techniques of the present disclosure.

Further, the present disclosure includes improvements to other technologies or technical fields at least because the present disclosure describes or introduces improvements in the field of project data storage/management/analytics. Namely, the trained machine learning model and/or the nesting data module executing on the server or other computing devices (e.g., user computing device) improves the field of project data storage/management/analytics by introducing the capability to predict/standardize data formats and optimize data storage accuracy/efficiency in a manner that was previously unachievable using conventional techniques. This improves over conventional techniques at least because such techniques lack the ability to predict/standardize data formats and are otherwise simply not capable of optimizing data storage accuracy/efficiency.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to data format templates, extracted data from training inputs, classifications, impacts, standardized data formats, etc.) to output the predicted classifications and/or predicted impacts configured to optimize project data storage through optimized data storage accuracy/efficiency.

Moreover, the present disclosure includes effecting a transformation or reduction of a particular article to a different state or thing, e.g., transforming or reducing the data storage accuracy/efficiency of a system from a non-optimal or error state to an optimal state by predicting classifications and impacts for extracted (non-standardized) data, converting the extracted data to standardized format(s) based on the predicted classifications, and storing the converted data in a project database.

In addition, the present disclosure includes specific features other than what is well-understood, routine, conventional activity in the field, or adding unconventional steps that confine the claim to a particular useful application, e.g., executing a trained ML model to extract the data from the input, and analyze the data to output (i) a predicted classification and (ii) a predicted impact associated with the project; converting the data to a standardized format based on the predicted classification; storing (i) the data and (ii) the predicted impact in the project database; and/or generating an indication of the data and the predicted impact for display to a user as part of the data inbox, among others.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example computing environment for optimizing project data storage, in accordance with various embodiments described herein.

FIG. 2A illustrates an example data inbox architecture and project data intake sequence utilizing a portion of the example computing environment of FIG. 1, in accordance with various embodiments described herein.

FIG. 2B illustrates an example data inbox-based data categorization workflow, in accordance with various embodiments described herein.

FIG. 3A illustrates an example project data standardization sequence, in accordance with various embodiments described herein.

FIG. 3B illustrates an example data inbox-based standardization architecture and workflow utilizing portions of the example computing environment of FIG. 1, in accordance with various embodiments described herein.

FIG. 4 illustrates an example method for optimizing project data storage, in accordance with various embodiments described herein.

FIGS. 5A-5D depict example data inbox graphical user interfaces (GUIs), in accordance with various embodiments described herein.

The Figures depict preferred embodiments for purposes of illustration only. Alternative embodiments of the systems and methods illustrated herein may be employed without departing from the principles of the invention described herein. Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive and/or limiting.

### DETAILED DESCRIPTION OF THE INVENTION

Generally speaking, the techniques of the present disclosure extract and analyze non-standardized project data received at a data inbox to determine optimal standardized data format(s) for the data, store the standardized data in a project database, and provide access to the standardized data to entities having access to the data inbox. Conventional techniques lack any such ability to extract, analyze, and convert data from an arbitrary, non-standardized format into a standardized format, and as a result, often misclassify and/or otherwise erroneously store received data into a project database and thereby cause further substantial issues with overall project data management. Consequently, the techniques of the present disclosure significantly improve the classification, storage, presentation, and analysis of such data, as compared to conventional techniques.

### Example Data Inbox Computing Environments, Architectures, and Workflows

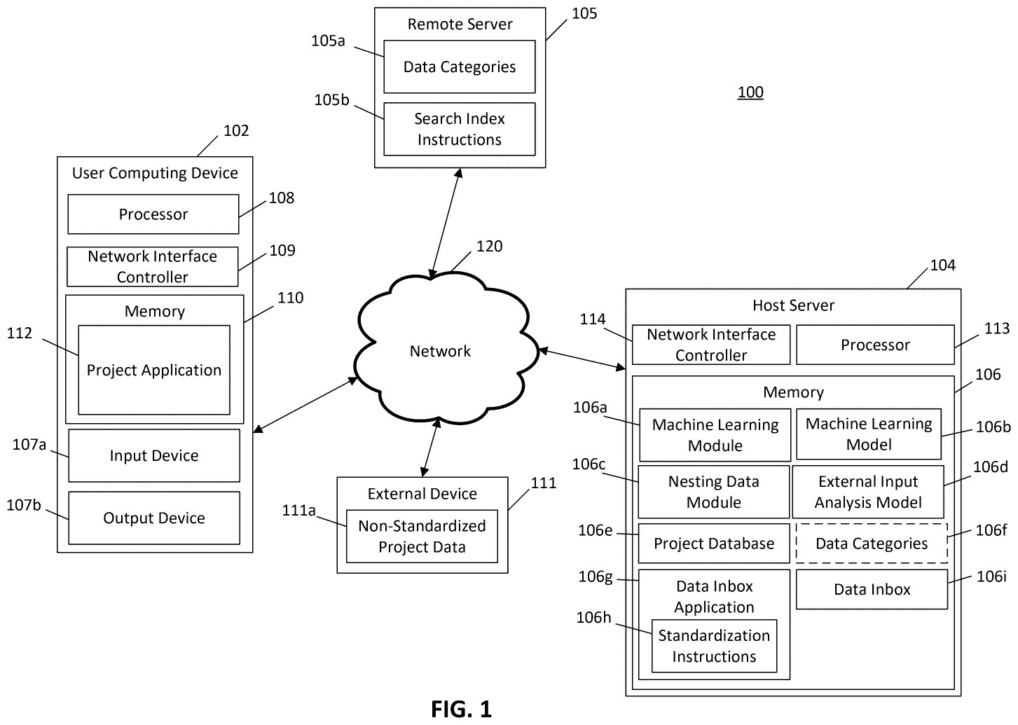

FIG. 1 depicts an example computing environment 100 for optimizing project data storage, in accordance with various embodiments described herein. The computing environment 100 includes a user computing device 102, a host server 104, a remote server 105, an external device 111, and a network 120. Some embodiments may include a plurality of user computing devices 102, a plurality of host servers 104, a plurality of remote servers 105, and/or a plurality of external devices 111.

The user computing device 102 includes a processor 108, a network interface controller 109, and a memory 110. The memory 110 stores a project application 112, which enables the user computing device 102 to access the project database 106e stored on the memory 106 of the host server 104.

The user computing device 102 may also include an input device 107a, and an output device 107b. The input device 107a may include any suitable device or devices for receiving input, such as one or more microphone, one or more camera, a hardware keyboard, a hardware mouse, a capacitive touch screen, etc. The output device 107b may include any suitable device for conveying output, such as a hardware speaker, a computer monitor, a touch screen, etc. In some cases, the input device 107a and the output device 107b may be integrated into a single device, such as a touch screen device that accepts user input and displays output. The user computing device 102 may communicate with the host server 104 and the remote server 105 across the network 120 via the network interface controller 109.

Generally, the host server 104 may include a memory 106, a processor 113, and a network interface controller 114. The memory 106 may store a ML module 106a, a machine learning model 106b, a nesting data module 106c, an external input analysis model 106d, a project database 106e, a set of data categories 106f, a data inbox application 106g storing standardization instructions 106h, and/or a data inbox 106i. In some embodiments, the nesting data module 106c and/or the external input analysis model 106d may be or include the machine learning model 106b to perform any/all of the actions described herein as performed by the machine learning model 106b.

Broadly, the host server 104 may execute/access each of the models/modules 106a-d, data inbox application 106g, and other stored data/instructions (e.g., 106e, 106f, 106h, 106i) to extract data from inputs, output predicted classifications and/or predicted impacts, convert extracted data from a non-standardized format into a standardized format, store the data, generate indications of standardized (and/or non-standardized) data and predicted impacts, determine predicted category mappings for input data categories, generate nested tables of mapped data categories, actively update values/date/categories within these tables over time as new data is received, and/or otherwise provide insights related to the data input by a user and/or otherwise received at the host server 104. As referenced herein, each of the models/modules 106a-d may be trained with and/or otherwise utilize artificial intelligence (AI) and/or machine learning (ML) techniques.

For example, the machine learning model 106b may be trained to extract data from an input and analyze the data to output (i) a predicted classification and (ii) a predicted impact associated with the project. This data, as referenced herein, may generally include any suitable data corresponding to a project (e.g., construction project). For example, data received at a data inbox 106i may include invoices, commitments (e.g., contracts), lien waivers, and/or any other suitable data corresponding to the project.

More specifically, the external input analysis model 106d is trained to analyze external data from external sources (e.g., external device 111) connected to the host server 104 and determine predicted classifications and impacts to the project based on this external data. The predicted classifications may generally include a transaction/data type and, in certain instances, a predicted data category. In some embodiments, the external input analysis model 106d may analyze the received inputs in combination with the machine learning model 106b (e.g., as two machine learning models) to determine a complete classification for received inputs. These external sources may generally be collected at the data inbox 106i where some/all documents and transactions may be sent to undergo any reviews and/or approval workflows before being accepted into a project.

The data inbox 106i is generally an email inbox configured to receive, store (e.g., temporarily), and display received data that is routed to the address of the inbox 106i. The data inbox 106i is illustrated as hosted on the host server 104, and the inbox 106i may be accessible by and displayed at the user computing device 102 for viewing by the user. In some embodiments, the data inbox 106i may have separate inboxes and corresponding receiving addresses for different transaction types, such that the external input analysis model 106d may classify different types of transactions (e.g., invoices, commitments, lien waivers) and perform separate analysis of those transaction types. Further, in certain embodiments, the data inbox 106i accesses received inputs via a listener interface configured to automatically retrieve and process the received inputs in real-time. In this manner, these embodiments enable the host server 104 to provide users with real-time updates, messages, alerts, and/or any other data related to their corresponding project(s). Of course, it should be appreciated that the data inbox 106i may store inputs (e.g., email messages) including any suitable data (e.g., text data, image data, video data, audio data, etc.)

The external input analysis model 106d may automatically extract non-standardized data from a document and/or other file that is sent to the data inbox 106i so that users of the host server 104 do not perform any data entry. Once the external input analysis model 106d extracts the non-standardized data, the model 106d may flag any potential issues that the external data may pose with the data already stored in the project database and/or otherwise associated with the project. The external input analysis model 106d may output a predicted classification which may indicate a particular transaction type (e.g., invoice, commitment, lien waiver, etc.), data category, normalized data category, line item, and/or other data stored as part of the project (e.g., in the project database) to which the external data applies and may output a predicted impact of the external data. The predicted impact may summarize how the external data may affect the portion of the project indicated by the predicted classification and may flag and/or otherwise indicate these potential issues with a predicted solution to help resolve the potential issues before the external data is accepted/stored as part of the project.

For example, the data inbox 106i connected to the external input analysis model 106d may receive an email message containing a document outlining a set of costs associated with a project in a non-standardized format. The external input analysis model 106d may analyze the document, extract the set of costs, compare those costs with the anticipated costs stored in the project database 106e, and may output the predicted classification and impact highlighting to a user what the document indicates and why it may be impactful to the project. The external input analysis model 106d may also take this cost data from the non-standardized document, automatically generate a second document that includes the cost data in a standardized format/schema based on the predicted classification, and store this standardized second document in the project database 106e and/or a relational database (not shown) stored therein. Thus, the external input analysis model 106d may take data from the data inbox 106i that is formatted in any manner the transmitting entity chooses and may normalize that data in the project database 106c to present a uniform experience for users (e.g., project managers, etc.) accessing the host server 104 to manage any number of projects and/or vendors.

Further, the host server 104 may determine a classification of the external input based on the predicted classification and update an entry of a data category within the nested table based on the classification. Additionally, or alternatively, the host server 104 may adjust an estimated value within the nested table based on the predicted impact. In certain embodiments, the external data may be stored in non-nested tables (e.g., within project database 106c) that reference the nested tables output by the nesting data module 106c. Adjusting the estimated values may be or include, for example, adjusting a total required budget for a project, shifting a timeline to accommodate an updated expense timing, and/or any other suitable adjustments to any suitable values stored in a nested/non-nested table in the project database 106e and/or otherwise associated with the project.

In some embodiments, the external input analysis model 106d analyzes the data included in an input received at the data inbox 106i and determines that a subset of the data is redundant data that is already stored as part of the project. The external input analysis model 106d then extracts the subset from the data without extracting the redundant data. Further, in certain embodiments, the predicted classification indicates a data type (e.g., a transaction type) associated with the data, and the predicted impact indicates one or more effects caused by the data to other data stored as part of the project.

For example, the input data may be an invoice, and the external input analysis model 106d may determine that the invoice includes data related to costs, as well as a name, an address, and contact information related to an entity that submitted the invoice and has submitted prior invoices. The external input analysis model 106d may determine that the data related to costs is new project data requiring a predicted classification and predicted impact, but the name, address, and contact information is redundant because this data has been previously extracted, classified, and stored in the project database 106e when the model 106d analyzed any of the prior invoices. Consequently, the external input analysis model 106d may extract the data related to the costs and may not extract and/or otherwise further analyze the name, address, or contact information.

Moreover, the external input analysis model 106d may determine that the costs indicated in the invoice correspond to an invoice data/transaction type associated with a particular data category (or categories), and that the costs have a predicted impact related to the particular data category. The external input analysis model 106d may also determine data categories for extracted data, as described herein, based on the available data categories 106f and/or as indicated in the project database 106e. Continuing the example, the costs may be associated with a service of a particular subcontractor, and the total remaining budget associated with the service is less than the value of the costs extracted from the invoice. The external input analysis model 106d may compare the costs value with the total remaining budget from the project database 106e, output a predicted impact indicating that the costs value will exceed the total remaining budget. This predicted impact may be included in an indication displayed for viewing by a user as part of the data inbox 106i and/or stored in the project database 106c. In certain embodiments, the indication also includes a reference link and/or another reference to the input received at the data inbox.

In some embodiments, the external input analysis model 106d identifies inconsistencies within the received data at the data inbox 106i based on other data stored in association with the project (e.g., in the project database 106e). The model 106d may further generate an alert for transmission to an entity that transmitted the data to the data inbox indicating the inconsistency. For example, an entity associated with the external device 111 may cause the device 111 to transmit non-standardized project data 111a to the host server 104 indicating a first contract for a particular service as part of the project represented by the project database 106e. The external input analysis model 106d may receive the data 111a and determine that the first contract represented by the data is inconsistent with a second contract stored in the project database 106c for the project, as the second contract is also for the particular service. This particular service indicated by both contracts may only be required once for the project, so the model 106d may determine that the first contract is inconsistent with the second contract. The model 106d may thereafter generate an alert indicating the inconsistency between the first and second contracts for display as part of the data inbox 106i.

In some embodiments, this analysis performed by the external input analysis model 106d (and/or other models described herein) is performed by utilizing at least one of: (i) optical character recognition (OCR), (ii) image recognition, (iii) object recognition, and/or (iv) image extrapolation. Continuing the prior example, the external in put analysis model 106d may utilize OCR to determine that a first set of characters present as part of the invoice represent a cost value and a second set of characters represent the name, address, and contact information of the entity. More specifically, the external input analysis model 106d may utilize OCR to identify specific locations within documents/files and correlate/associate the extracted/identified data from a particular document to known areas/fields of standardized document templates. Using this OCR analysis and field matching, the external input analysis model 106d and/or other suitable model(s) described herein may also generate standardized templates for document/file types by determining and saving/storing templates based on a shared set of areas/fields common to a particular document(s)/file(s).

The data inbox application 106g generally manages the data flow and execution of the various models (e.g., model 106d) related to the data inbox 106i. For example, the data inbox application 106g executes the external input analysis model 106d to extract data and determine predicted classifications and impacts associated with the data. The data inbox application 106g includes standardization instructions 106h that may inform the formatting applied to data in response to the classifications output by the model 106d. For example, the external input analysis model 106d may output a predicted classification for received data indicating that the data is likely of a first classification (e.g., invoice, commitment, lien waiver). The data inbox application 106g may receive this predicted classification and may format the data in accordance with the formatting standards associated with the first classification, as indicated by the standardization instructions 106h. In some embodiments, the standardization instructions 106h include one or more formatting templates that each correspond with one or more predicted classifications output by the external input analysis model 106d.

In some embodiments, the data inbox application 106g converts the data to a standardized format by determining one or more data input locations within a file (e.g., a file following the standardized format) associated with each individual data value from the data based on the data type indicated by the predicted classification. The standardization instructions 106h may indicate where specific data values from data with a particular classification should be stored in a file following the standardized format. By inputting each data value in the specified location within the file, the relevant data values from the data are thereby accessible in a standardized format and the application 106g can readily access and utilize the values. Namely, the data inbox application 106g can reference the standardization instructions 106h and/or otherwise leverage the standardized format to quickly access/retrieve the data values without needlessly processing the file to determine where such data values may be, which consequently reduces processing resources required to manage/utilize the data in the database 106e. Further, the project database 106e may be a relational database, and the data inbox application 106g may input the individual data values into the one or more data input locations and store the file in the relational database.

In certain embodiments, the data inbox application 106g transmits messages for users connected to the data inbox in real-time that indicate the data and the predicted impact(s). For example, the model 106d may determine that data extracted from an input received at the data inbox 106i will exceed several thresholds related to the project. The application 106g may receive this output from the model 106d and generate/transmit a message in real-time to all connected users of the data inbox 106i indicating that the data extracted from the input will exceed several thresholds related to the project. The application 106g may include any other data related to the project, such as the thresholds, relevant data categories, entities related to the data in those data categories, etc. In this manner, all connected users to the data inbox 106i may receive real-time updates related to any/all data uploaded/transmitted to the data inbox 106i without constantly monitoring the inbox 106i.

Further, in certain embodiments, the project database 106e include a plurality of standardized data, and the data inbox application 106g automatically generates reports based on the standardized data stored in the project database 106e. The data inbox application 106g determines that a report threshold is exceeded based on the data included in the input, and automatically generates a report associated with the project based on the data included in the input and at least a portion of the plurality of standardized data stored in the database 106c. Further, the application 106g generates an indication of the report for display to the user as part of the data inbox. Report threshold may generally correspond to any suitable metrics related to a project, such as a chronological threshold for a particular entity, data category, and/or classification. For example, the data inbox application 106g may determine that a critical timing milestone has passed for a first and second service (e.g., as reflected by a recently received invoice) of the project, such that the application 106g should generate reports related to the first and second service. Accordingly, the application 106g may generate one or more reports using the standardized data from the database 106e to reflect the amounts paid, to be paid, refunded, etc. to-date, and may further include any suitable data from the database 106e that is related to the first service, second service, and/or related services. In some embodiments, the data inbox application 106g may not generate reports, and the application 106g may access and/or transmit relevant data to other application(s) executing instructions stored in the memory 106 (e.g., draw request instructions (not shown), report building instructions (not shown)) to generate reports. In any event, generated reports may be in any suitable format (e.g., portable document format (PDF)).

In some embodiments, the data inbox application 106g may utilize parallel processing to expedite certain processes described herein. For example, the data inbox 106i may receive two inputs simultaneously or nearly simultaneously. In this example, the data inbox application 106g may execute the external input analysis model 106d to extract the data from both inputs in parallel utilizing parallel processing. The application 106g may also execute the external input analysis model 106d to analyze both sets of data to output (i) two predicted classifications and (ii) two predicted impacts associated with the project in parallel utilizing parallel processing. The application 106g may also convert both sets of data to one or more standardized formats based on the predicted classifications in parallel utilizing parallel processing. Moreover, the application 106g may store (i) both sets of data and (ii) both predicted impacts in the project database 106e in parallel utilizing parallel processing, and generate indications of both sets of data and both predicted impacts for display to the user as part of the data inbox 106i in parallel utilizing parallel processing. In certain instances, the application 106g and/or the data inbox 106i may receive two inputs in parallel utilizing parallel processing.

In certain embodiments, the machine learning model 106b may be trained to determine a predicted data category mapping for a first data category that maps the first data category to a normalized data category. These data categories, as referenced herein, may generally indicate a category or type of data that may be aggregated, collected, and/or stored together. The normalized formats, as referenced herein, may indicate broader categories/types of data, into which, other data categories (e.g., user input data categories) may be grouped. As an example, a first data category provided to the trained ML model 106b may be “Permanent Signage” for signage used as part of a construction/real estate project. The trained ML model 106b may receive this first data category and may determine a predicted data category mapping indicating that the first data category corresponds (i.e., maps) to a normalized data category of “Signage-Non marketing” that may include other types of non-marketing signage beyond the permanent signage indicated by the user. This normalized data category may also include data corresponding to data categories such as “Monument Signs”, “Building Signage”, and/or others.

When the trained ML model 106b outputs the predicted classification and/or impact, the processors 113 may execute the nesting data module 106c to generate nested tables with data corresponding to the predicted data category mapping. The nesting data module 106c may input data from a first data category into a first table with a first file size and collapse the first table with a second table that includes a second data category that is related to the first data category to generate a nested table. In particular, the nesting data module 106c may collapse the two tables together such that the nested table has a third file size that is less than a combination of the first file size and the second file size. Accordingly, the nesting data module 106c may reduce the overall storage capacity requirements for any project by collapsing data tables that have similar data (e.g., based on the predicted data category mapping) into a nested table with a smaller overall storage/file size.

Continuing the prior example, the nesting data module 106c may receive the first data category and the predicted data category mapping, and may input the first data category (e.g., any data associated with the first data category) into a first table having a first file size of 5 MB. The nesting data module 106c may then cause the processors 113 to collapse the first table with a second table that includes a second data category that is related to the first data category to generate a nested table. The first data category may be “Permanent Signage”, the second data category may be “Building Signage”, and the nested table may correspond to a normalized data category of “Signage-Non marketing”. The second data table may have a second file size of 5 MB. However, as a result of the nesting performed as part of the nesting data module 106c, the nested table may have a third file size of 8 MB, which is less than a combination of the first file size (5 MB) and the second file size (5 MB) (e.g., a total, non-nested file size of 10 MB).

It should be appreciated that the nesting data module 106c may collapse any suitable number of data tables together (e.g., three or more), and that the above example is for the purposes of discussion only. Thus, the nesting data module 106c may significantly reduce the number of data tables required to store the relevant data for a particular project. Further, the nesting data module 106c enables more flexible data access patterns and saves computational resources when accessing and manipulating the nested data tables. Moreover, the nesting data module 106c may utilize any suitable protocol or structure, such as a PostgreSQL LTREE data module, to create and/or access the nested tables.

In certain embodiments, the nesting data module 106c may also include instructions configured to cause a processor (e.g., processors 108, 113) to render a project GUI that includes the nested table(s) for access by a user (e.g., of the user computing device 102). Further in these embodiments, the processors 108 and/or the processors 113 may receive input from the user corresponding to the project GUI, such as an interaction (e.g., click, tap, swipe, voice command, gesture, etc.) specifically associated with the nested table(s) displayed on the project GUI. Responsive to receiving this input from the user, the processors 108 and/or the processors 113 may execute the nesting data module to expand the nested table into, for example, a first table and a second table from which the nested table was originally created.

The processors 113 may then store the nested tables in the project database 106e for future access and/or updates/changes. The project database 106e may be stored on the host server 104 and/or may be stored in a remote location (not shown), such as the remote server 105. Generally, the remote server 105 may include a set of data categories 105a and a set of search index instructions 105b. The set of data categories 105a may include any suitable number of different data categories that may be relevant to any particular project, set of projects, or industry/industries. The set of data categories 105a may also be similar/identical to the set of data categories 106f that may be stored in the memory 106 of the host server 104.

The set of search index instructions 105b may be or include instructions configured to cause the remote server 105 to search through the set of data categories 105a to return probable/likely data category mappings for any input data categories. For example, the host server 104 may receive an input from a user (e.g., via user computing device 102) indicating the data category “Project Software and Applications”, and the host server 104 may format an input query (e.g., via the trained ML model 106b) that is transmitted to the remote server 105 via the network interface controller 114. For example, the trained ML model 106b may be or include a large language model (LLM) configured to receive input data categories from a user, semantically/syntactically analyze the input data categories, and format an input query for transmission to the remote server 105 to query the set of data categories 105a.

Upon receipt of the input query, the set of search index instructions 105b may cause the remote server 105 to search the set of data categories 105a for normalized data categories that may correspond to the “Project Software and Applications” data category provided by the user. The set of search index instructions 105b may cause the remote server 105 to return a listing of normalized data categories that may correspond to the “Project Software and Applications” data category, and this listing may provide a ranking of each normalized data category and/or an indication of a confidence value/score for each normalized data category included as part of the listing. The listing may include, for example, “General Administrative & Overhead” as a first potential normalized category with a 95% confidence level/value, “Marketing” as a second potential normalized category with a 50% confidence level/value, and “Legal Services” as a third potential normalized category with a 15% confidence level/value.

The remote server 105 may return this listing to the host server 104, where the trained ML model 106b may evaluate the listing and determine a predicted data category mapping for the first data category. Thus, in certain embodiments, the host server 104 may transmit data to a remote server 105 for processing as part of the actions described herein. More specifically, in some embodiments, the remote server 105 may be or be part of a cloud processing architecture, and the host server 104 may transmit input queries including data categories and/or other data for processing by the cloud processing architecture, of which the remote server 105 is a part. However, in certain aspects, the remote server 105 may be part of the host server 104 and/or the user computing device 102.

In certain embodiments, the memories 110, 106 may store instructions that cause the processors 108 and/or the processors 113 to render a data inbox GUIs configured to display data stored in standardized formats as part of the project database 106e. For example, the project application 112 stored in the memory 110 of the user computing device 102 may include instructions to render the data inbox GUIs in response to receiving updates to the data inbox 106i, such as predicted classifications and/or predicted impacts of received and extracted data and/or other data stored in the project database 106e. In some instances, these instructions further cause the processors 108 and/or the processors 113 to receive a predicted impact associated with data received at the data inbox 106i and determine that the predicted impact indicates one or more values stored in the project database 106e exceeding a threshold value. The instructions may then cause the processors 108 and/or the processors 113 to adjust and/or newly render a graphical display element on the data inbox GUIs corresponding to the predicted impact indicating the one or more values stored in the project database 106e exceeding the threshold value.

More broadly, each of the modules stored in memory 106 implement specific functionality in order to optimize project data storage. For example, the ML module 106a includes computer-executable instructions for training and operating one or more ML model. In general, the ML module 106a may train one or more ML models (e.g., ML model 106b) by establishing a network architecture, or topology, and adding layers that may be associated with one or more activation functions (e.g., a rectified linear unit, softmax, etc.), loss functions and/or optimization functions. As an example, one or more types of artificial neural networks may be employed, including without limitation, recurrent neural networks, convolutional neural networks, and/or deep learning neural networks. Data sets used to train the artificial neural network(s) may be divided into training, validation, and testing subsets, and these subsets may be encoded in an N-dimensional tensor, array, matrix, or other suitable data structures. Training may be performed by iteratively training the network using labeled training samples.

Training of the artificial neural network may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction. In certain embodiments, a Bayesian model may be used to train the ML model 106b.

In some embodiments, the one or more ML models may include an artificial neural network having an input layer, one or more hidden layers, and an output layer. Each of the layers in the artificial neural network may include an arbitrary number of neurons. The plurality of layers may chain neurons together linearly and may pass output from one neuron to the next or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

Further, in certain embodiments, the ML module 106a may train the ML model 106b to employ supervised learning, which involves identifying patterns in existing data to make predictions about subsequently received data. Specifically, the ML model 106b may be “trained” using training data, which includes example inputs and associated example outputs. Based upon the training data, the ML model 106b may generate a predictive function which maps outputs to inputs and may utilize the predictive function to generate machine learning outputs based upon data inputs. The exemplary inputs and exemplary outputs of the training data may include any of the data inputs or machine learning outputs, as described herein. In the exemplary embodiment, a processing element may be trained by providing it with a large sample of data with known characteristics or features.

In another embodiment, the ML module 106a may train the ML model 106b to employ unsupervised learning, which involves finding meaningful relationships in unorganized data. Unlike supervised learning, unsupervised learning does not involve user-initiated training based upon example inputs with associated outputs. Rather, in unsupervised learning, the ML model 106b may organize unlabeled data according to a relationship determined by at least one machine learning method/algorithm employed by the ML model 106b. Unorganized data may include any combination of data inputs and/or machine learning outputs, as described herein.

In yet another embodiment, the ML module 106a may train the ML model 106b to employ reinforcement learning, which involves optimizing outputs based upon feedback from a reward signal. Specifically, the ML model 106b may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, the ML model 106b may employ natural language processing (NLP) functions, which generally involves understanding verbal/written communications and generating responses to such communications. The ML model 106b may be trained to perform such NLP functionality using a symbolic method, machine learning models, and/or any other suitable training method. As an example, the ML model 106b may be trained to perform at least two techniques that may enable the ML model 106b to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the ML model 106b may generate textual transcriptions from verbal responses from a user in a data stream.

Semantic analysis generally involves analyzing text in order to understand and/or otherwise capture the meaning of the text. In particular, the ML model 106b applying semantic analysis may study the meaning of each individual word contained in a textual transcription in a process known as lexical semantics. Using these individual meanings, the ML model 106b may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the ML model 106b may generate one or more intent interpretations based upon one or more textual transcriptions from a syntactic analysis.

In some embodiments, the ML module 106a may train the ML model 106b as a generative AI model (also referenced as generative ML models). Data input into such a generative AI/ML model may include standardized data formats, data classifications, data impacts, data categories, data category mappings, normalized data categories, and other data. The data input into the generative AI/ML model may include text, documents, and images, such as text, documents and images related to project data, standardized data formats, data classifications, data impacts, data categories, normalized data categories, data category mappings, and other data. In certain embodiments, a generative AI/ML model may be or include a ChatGPT model. The generative AI/ML model may also employ supervised or unsupervised machine learning techniques, which may be followed by, and/or used in conjunction with, reinforced or reinforcement learning techniques. The generative AI/ML model may also generate audible or verbal output, text or textual output, visual or graphical output, output for use with speakers and/or display screens, and/or other types of output for user and/or other computer or bot consumption.

After training, ML programs (or information generated by such ML programs) may be used to evaluate additional data. Such data may be and/or may be related to standardized data formats, data classifications, data impacts, and/or other project data that was not included in the training dataset. The trained ML programs (or programs utilizing models, parameters, or other data produced through the training process) may accordingly be used for determining, assessing, analyzing, predicting, estimating, evaluating, or otherwise processing new data not included in the training dataset. Such trained ML programs may, therefore, be used to perform part or all of the analytical functions of the methods described elsewhere herein.

It is to be understood that supervised ML and/or unsupervised ML may also comprise retraining, relearning, or otherwise updating models with new, or different, information, which may include information received, ingested, generated, or otherwise used over time. Further, it should be appreciated that, as previously mentioned, the ML model 106b may be used to output a predicted data classification, predicted data impact and/or any other values, responses, or combinations thereof using artificial intelligence or, in alternative aspects, without using artificial intelligence.

Moreover, although the methods described elsewhere herein may not directly mention ML techniques, such methods may be read to include such ML for any determination or processing of data that may be accomplished using such techniques. For example, any of the ML model 106b, the nesting data module 106c, the external input analysis model 106d, and/or any other models, modules, and/or other software described herein may be trained to use, and may actively employ, any of the ML techniques described herein. In some aspects, such ML techniques may be implemented automatically upon occurrence of certain events or upon certain conditions being met. In any event, use of ML techniques, as described herein, may begin with training a ML program, or such techniques may begin with a previously trained ML program.

Referring again to FIG. 1, each of the user computing device 102, the host server 104, the remote server 105, and/or the external device 111 may be individual computing devices, a group of multiple computing devices, an individual server, a group (e.g., cluster) of multiple servers, and/or another suitable type of computing device or system (e.g., a collection of computing resources). In some aspects, one or more components of the user computing device 102, the host server 104, the remote server 105, and/or the external device 111 may be embodied by one or more virtual instances (e.g., a cloud-based virtualization service). In such cases, the one or more user computing devices 102, the one or more host servers 104, the one or more remote servers 105, and/or the one or more external devices 111 may be included in a remote data center (e.g., a cloud computing environment, a public cloud, a private cloud, etc.).

However, regardless of the specific implementation of the user computing device 102, the host server 104, the remote server 105, and/or the external device 111 a user may utilize the user computing device 102 to access the host server 104, the remote server 105, and/or the external device 111 in order to access the data stored therein (e.g., 105a-b, 106a-i, 111a). In this manner, the user computing device 102 may retrieve and/or otherwise access the data required to optimize project data storage.

In any event, as previously mentioned, the user computing device 102 and the host server 104 include processors 108, 113 and network interface controllers 109, 114. The processors 108, 113 may include any suitable number of processors and/or processor types, such as CPUs and one or more graphics processing units (GPUs). Generally, the processors 108, 113 are configured to execute software instructions stored in the memories 110, 106, such as the project application 112, the ML module 106a, the ML model 106b, the nesting data module 106c, the external input analysis model 106d, the data inbox application 106g, and/or other instructions. More generally, the processors 108, 113 may be connected to the memories 110, 106 via a computer bus responsible for transmitting electronic data, data packets, or otherwise electronic signals to and from the processors 108, 113 and the memories 110, 106 in order to implement or perform the machine readable instructions, methods, processes, elements or limitations, as illustrated, depicted, or described for the various flowcharts, illustrations, diagrams, figures, and/or other disclosure herein.

The processors 108, 113 may interface with the memories 110, 106 via the computer bus to execute an operating system (OS). The processors 108, 113 may also interface with the memories 110, 106 via the computer bus to create, read, update, delete, or otherwise access or interact with the data stored in the memories 110, 106. The data stored in the memories 110, 106 may include all or part of any of the data or information described herein, and/or any other data stored in the memories 110, 106.

The memories 110, 106 may include one or more persistent memories (e.g., a hard drive/solid state memory) and may store one or more set of computer executable instructions/modules. In general, a computer program or computer based product, application, or code (e.g., the ML module 106a and other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processors 108, 113 (e.g., working in connection with the data in the memories 110, 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The memories 110, 106 may include one or more forms of non-transitory, volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In certain aspects, the memories 110, 106 may store an operating system (OS) (e.g., Microsoft Windows, Linux, Unix, etc.) capable of facilitating the functionalities, applications, methods, or other software as discussed herein.

The memories 110, 106 may also store any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, or otherwise be part of the various applications/modules/models described herein, where each may be configured to facilitate their various functionalities discussed herein. It should be appreciated that one or more other applications may be envisioned and that are executed by the processors 108, 113.

The network interface controllers 109, 114 may include any suitable network interface controller(s), such as wired/wireless controllers (e.g., Ethernet controllers), and facilitate bidirectional/multiplexed networking over the network 120 between the user computing device 102 and other components of the environment 100 (e.g., the host server 104, the remote server 105, the external device 111, etc.). The network 120 may be a single communication network or may include multiple communication networks of one or more types (e.g., one or more wired and/or wireless local area networks (LANs), and/or one or more wired and/or wireless wide area networks (WANs) such as the Internet). The network 120 may enable bidirectional communication between the host server 104, the user computing device 102, the remote server 105, the external device 111, and/or between multiple user computing devices 102, for example. According to some embodiments, the user computing device 102, the host server 104, the remote server 105, and/or the external device 111 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a computer network.

In some embodiments, the user computing device 102, the host server 104, the remote server 105, and/or the external device 111 may include a client-server platform technology such as ASP.NET, Java J2EE, Ruby on Rails, Node.js, a web service or online API, responsive for receiving and responding to electronic requests. The user computing device 102, the host server 104, the remote server 105, and/or the external device 111 may implement the client-server platform technology that may interact, via the computer bus, with the memories 110, 106 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

The user computing device 102, the host server 104, the remote server 105, and/or the external device 111 may further include or implement an operator interface configured to present information to an administrator or operator and/or receive inputs from the administrator or operator. For example, an operator interface may provide a display screen (e.g., via input device 107a or output device 107b). The user computing device 102, the host server 104, the remote server 105, and/or the external device 111 may also provide I/O components (e.g., ports, capacitive or resistive touch sensitive input panels, keys, buttons, lights, LEDs), which may be directly accessible via or attached to the user computing device 102, the host server 104, the remote server 105, and/or the external device 111 or may be indirectly accessible via or attached to an internal user computing device. According to some embodiments, an administrator or operator may access the host server 104 and/or the remote server 105 by the user computing device 102 to review information (e.g., project data updates, data category predictions, etc.), make changes, input data categories, and/or perform other functions.

As described above herein, in some embodiments, the user computing device 102, the host server 104, the remote server 105, and/or the external device 111 may perform the functionalities as discussed herein as part of a “cloud” network or may otherwise communicate with other hardware or software components within the cloud to send, retrieve, or otherwise analyze data or information described herein.

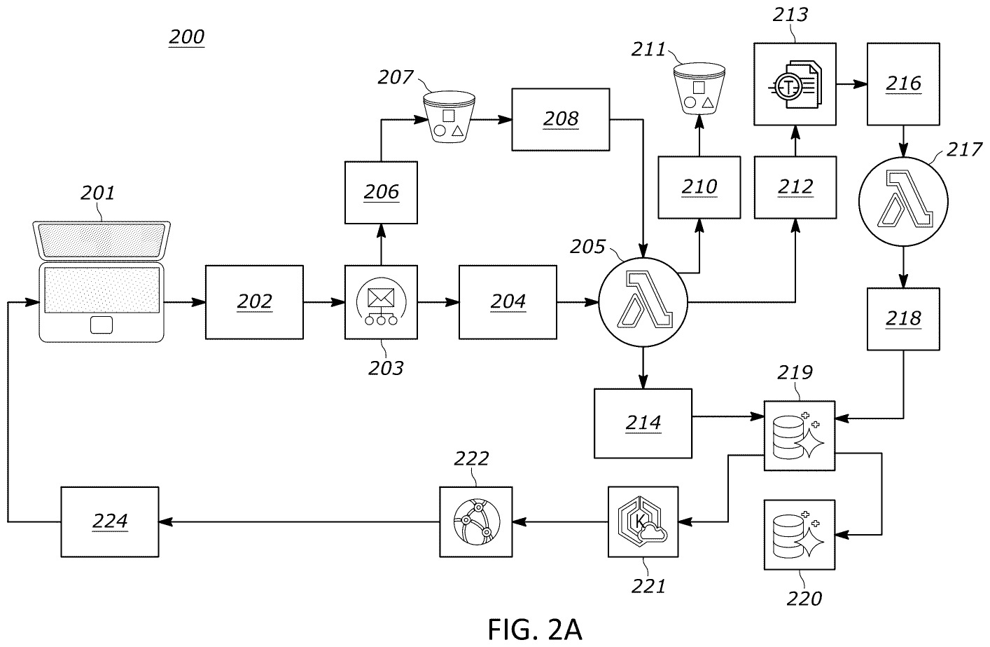

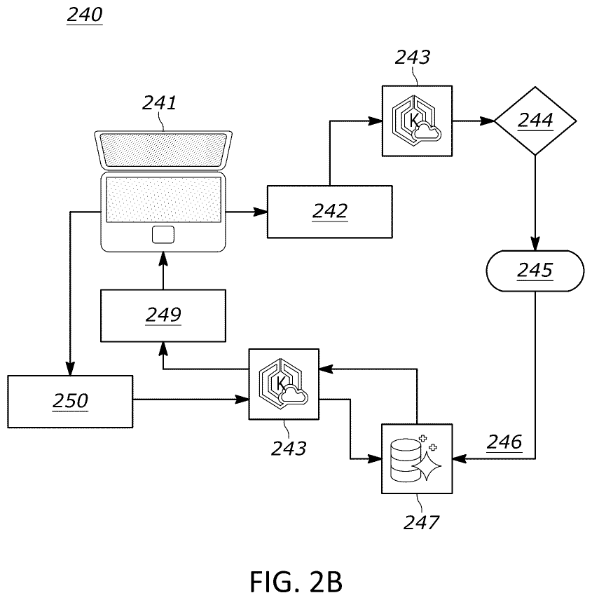

FIG. 2A illustrates an example data inbox architecture and project data intake sequence 200 utilizing a portion of the example computing environment of FIG. 1, in accordance with various embodiments described herein. Broadly speaking, the example data inbox architecture and project data intake sequence 200 may represent some/all of the actions performed by the data inbox application 106g and external input analysis model 106d, as described herein.

The sequence 200 includes a user computing device 201 that receives inputs from external sources (e.g., external device 111). Generally speaking, inputs received at the device 201 are in the form of PDF documents transmitted via email, many of which arrive in non-standardized formats. However, it should be appreciated that the inputs received at the device 201 may be any suitable files (e.g., images, text documents, audio files, video files, etc.) in any suitable format.

When the user computing device 201 receives an input, the device 201 forwards the input (block 202) to an input ingestion processor 203. The input ingestion processor 203 transmits a message/indication (block 204) to an input data processor 205 indicating the sending address (e.g., email address, transmitting entity) and a receiving address that may be a custom address associated with a particular transaction type, data category, project, etc. Additionally, the input ingestion processor 203 stores (block 206) the raw input (e.g., email message and any attachments) in a raw input storage location 207 (e.g., project database 106c).

The input data processor 205 then accesses and retrieves/downloads the raw input (block 208) from the raw input storage location 207. The input data processor 205 processes the raw input to determine a classification (e.g., transaction type) corresponding to the raw input. The input data processor 205 also stores/uploads all attachments included as part of the raw input (block 210) to an attachment storage location 211. In many instances, the attachments included as part of the raw input include PDFs, and the attachment storage location 211 may be configured to store PDF files.

Regardless, the input data processor 205 transmits any inputs representing particular transaction types (block 212) to a data extraction service 213. The data extraction service 213 extracts the text and/or other data from the input and transmits the extracted text/data (block 216) to a data analysis processor 217. The data analysis processor 217 analyzes the extracted text/data to identify particular values indicated in the text/data. For example, the data analysis processor 217 may receive a plurality of text from the data extraction service 213 that the input data processor 205 classified as an invoice. The data analysis processor 217 may identify various data values within the plurality of text corresponding to the invoice classification, such as a cost/amount, entity name, date, invoice number, and/or other data values.

In any event, when the data analysis processor 217 analyzes the extracted data and identifies values in the extracted data, the processor 217 may transmit the identified values (block 218) to a database 219 (e.g., project database 106e). Moreover, the input data processor 205 may transmit a reference/indication of the raw input (block 214) to the database 219 to store the raw input (e.g., email message, PDF document(s)) in association with the corresponding project, entity, classification, data categories, etc. The database 219 may also replicate each entry (e.g., from blocks 214, 218) in a replicated database 220 for data redundancy and security. In certain embodiments, the database 219 and/or the replicated database 220 may be or include cloud databases.

Thereafter, a user may access any of the data stored in the database 219. In particular, the user may access the data inbox (e.g., data inbox 106i) to view received inputs. When the user interacts with the data inbox to retrieve and view an input, a data server 221 (e.g., host server 104) may retrieve the relevant input from the database 219 and utilize an input delivery system 222 to transmit the input (block 224) to the user computing device 201.

Each of the inputs described herein may relate to various data categories associated with a project. In certain instances, the inputs received at the data inbox 106i may motivate and/or necessitate determining a data categorization associated with new data reflected in the inputs. To better understand this data categorization determination for new inputs, FIG. 2B illustrates an example data inbox-based data categorization workflow 240, in accordance with various embodiments described herein.

The workflow 240 includes a user computing device 241 receiving an input, and forwarding and/or otherwise transmitting the input (block 242) to a server 243. For example, the input may be an invoice from a subcontractor that has not yet submitted an invoice corresponding to a particular project. The server 243 then examines the input (block 244) to determine a data category associated with the input. Continuing the prior example, the server 234 analyzes the invoice from the subcontractor, and may determine that the invoice corresponds to several data categories based on the services, materials, dates (e.g., corresponding to a project timeline stored in the project database 106e), invoice formatting, and/or other data or characteristics of the invoice.

Accordingly, the server 243 stores the input and the determined data categories (block 246) in a database 247. In certain embodiments, the database 247 may be or include a cloud database. When the input is stored in the database 247 such that the data included therein is stored in association with the relevant data categories, the server 243 may access the data quickly to determine insights, generate reports, and/or otherwise provide the data to the user. For example, the server 234 may provide the input and corresponding data categories to the user computing device 241 for viewing by the user (block 249), and the user may request a change to one or more of the determined data categories. The user may cause the user computing device 241 to transmit the requested change (block 250) to the server 234, which may store the change to the data categories in the database 247.

### Example Data Inbox Standardization Sequences and Architectures

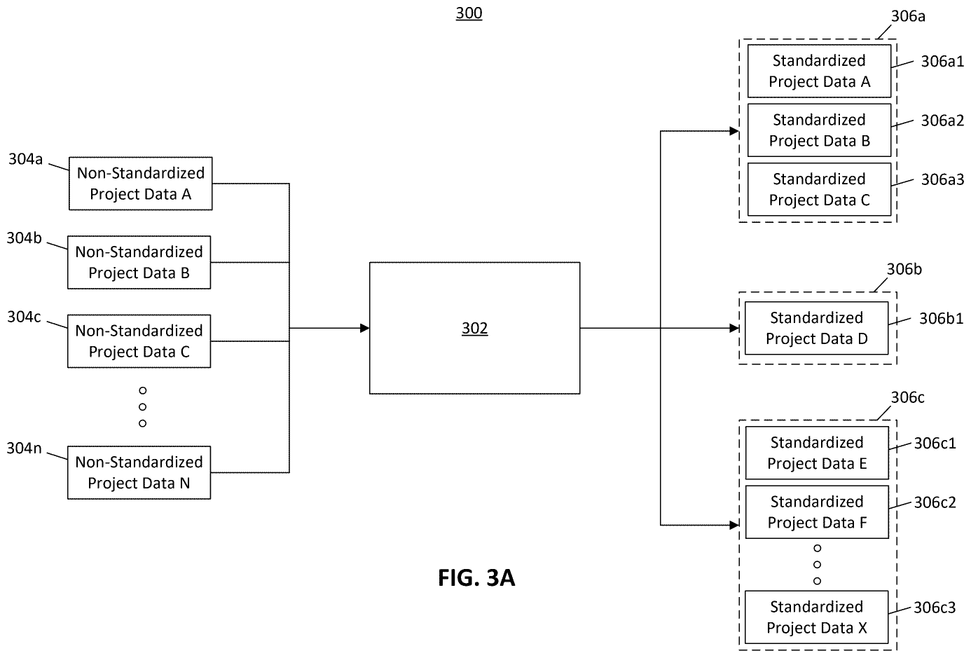

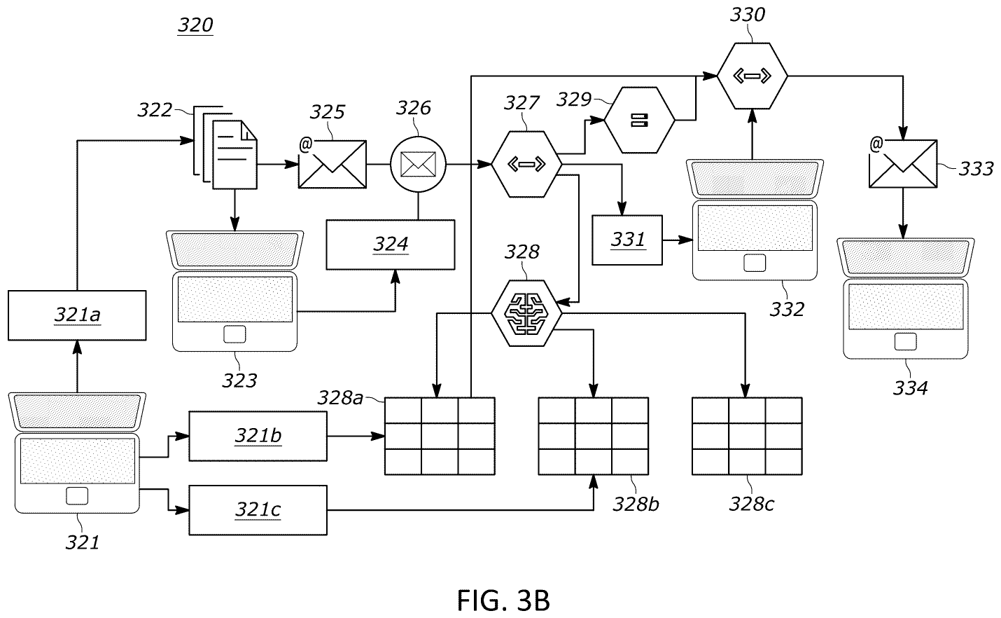

FIG. 3A illustrates an example project data standardization sequence 300, in accordance with various embodiments described herein. Generally speaking, the example project data standardization sequence 300 includes a standardization stage 302 that utilizes portions of the example computing environment 100 (e.g., external input analysis model 106d, data inbox application 106g, standardization instructions 106h) to convert a plurality of non-standardized project data 304a-304n into a plurality of standardized project data 306a1-3, 306b1, 306c1-3.

As illustrated in FIG. 3A, the standardization stage 302 receives the plurality of non-standardized project data 304a-n, where N/n may be any integer value. While referenced herein as a plurality of non-standardized project data 304a-n, in certain instances, N/n may be 1, such that the standardization stage 302 receives a single non-standardized project data (e.g., non-standardized project data A 304a). Further, in some instances, N/n may be greater than 1, and the plurality of non-standardized project data 304a-n may include project data corresponding to multiple, different projects. Regardless, each non-standardized project data 304a-n received at the standardization stage 302 includes project data that is formatted in an arbitrary (e.g., non-standardized) format, and each individual non-standardized project data 304a-n may include project data that is formatted in different, arbitrary formats.

For example, the non-standardized project data A 304a may include a commitment with multiple values (e.g., fees, costs, expenses) related to a first project in a first non-standardized format, the non-standardized project data B 304b may include a lien waiver with multiple values (e.g., description of property, dates, costs/fees) related to the first project in a second non-standardized format, and the non-standardized project data C 304c may include an invoice with multiple values (e.g., fees, costs, services) related to a second project in a third non-standardized format. The standardization stage 302 receives and extracts project data from each of the non-standardized project data A-C 304a-c and outputs a predicted classification for the extracted project data.

In particular, the predicted classification for the extracted project data from the data 304a may indicate that the data 304a is or includes a commitment and/or that the extracted project data is or is associated with one or more data categories related to fees, costs, expenses, etc. of the first project. The predicted classification for the extracted project data from the data 304b may indicate that the data 304b is or includes a lien waiver and/or that the extracted project data is or is associated with one or more data categories related to costs/fees, penalties, etc. of the first project. The predicted classification for the extracted project data from the data 304c may indicate that the data 304c is or includes an invoice and/or that the extracted project data is or is associated with one or more data categories related to services, costs, fees, etc. of the second project.

Continuing the prior example, the standardization stage 302 may also output a predicted impact for each non-standardized project data 304a-c. For example, the predicted impact associated with the extracted project data from data 304a may indicate that the extracted project data does not violate any thresholds (e.g., total budget for a service indicated in the commitment) or prior agreements/terms of the first project. The predicted impact associated with the extracted project data from data 304b may indicate that the extracted project data includes a conflict with a second lien waiver or other contract/agreement (e.g., associated with a single property) of the first project. In this circumstance, the standardization stage 302 may also output a recommendation or predicted resolution (e.g., adjusting terms in the lien waiver) to avoid or resolve the issues indicated in the predicted impact for the extracted project data from data 304b. The predicted impact associated with the extracted project data from data 304c may indicate that the extracted project data does not violate any thresholds (e.g., allocated budget for individual data categories) or prior agreements/terms of the second project.

Further, the standardization stage 302 determines a standardized format for each non-standardized project data (e.g., 304a-n) based on the predicted classification(s), converts the data to the respective standardized format(s), and stores the standardized data and predicted impacts in one or more storage locations (e.g., storage locations 306a-c). Each of the storage locations 306a-c may represent storage locations within a project database (e.g., project database 106c) that correspond to particular standardization formats, data categories, and/or projects.

For example, the storage locations 306a-c may each represent a storage location within the project database for project data associated with particular data categories of a single/multiple projects. In this example, the storage location 306a stores the standardized project data A-C 306a1-3 that is all associated with a first data category and formatted in one or more standardized formats, the storage location 306b stores the standardized project data D 306b1 that is associated with a second data category and formatted in a standardized format, the storage location 306c stores the standardized project data E-X 306c1-3 that is all associated with a third data category and formatted in one or more standardized formats, and the first, second, and third storage locations 306a-c may correspond to one or more different projects.

As another example, the storage locations 306a-c may each represent storage locations within the project database for all project data that is formatted in accordance with respective standardized formats. In this examples, the storage location 306a stores the standardized project data A-C 306a1-3 that is all formatted in accordance with a first standardized format, the storage location 306b stores the standardized project data D 306b1 that is formatted in accordance with a second standardized format, the storage location 306c stores the standardized project data E-X 306c1-3 that is all formatted in accordance with a third standardized format, and the first, second, and third standardized formats are all distinct from one another.

Thus, the example project data standardization sequence 300 represents a significant improvement over conventional project data storage techniques that are unable to intake, interpret, accurately store, and/or otherwise process non-standardized project data. The standardization stage 302 intelligently analyzes and extracts data from the non-standardized project data to determine predicted classification(s), impacts, data categories, and/or projects corresponding to the project data, re-formats the project data into a standardized format based on the predicted classification and stores the standardized project data in a storage location associated with the correct project, data category, and classification.

By contrast, conventional techniques struggle to accurately interpret such non-standardized project data, and frequently misclassify, mis-categorize, and/or errantly store such non-standardized project data without adjusting the format, and thereby create substantial issues with the ongoing data management of the project, as described herein. Such issues are further compounded when extrapolated across multiple projects, where conventional techniques may misplace data in storage locations associated with different/wrong projects. Accordingly, the example project data standardization sequence 300 (and more particularly, the standardization stage 302) improves over these conventional techniques by creating a more accurate project data storage system, in part, through project data format standardization to aid in storage/retrieval efficiency within and across multiple projects.

FIG. 3B illustrates an example data inbox-based standardization architecture and workflow 320 utilizing portions of the example computing environment of FIG. 1, in accordance with various embodiments described herein. Generally, the example data inbox-based standardization architecture and workflow 320 illustrates how the host server (e.g., host server 104) and/or other suitable components standardize received inputs at a data inbox (e.g., data inbox 106i) to achieve many of the advantages described herein.

The example data inbox-based standardization architecture and workflow 320 includes a computing device 321 (e.g., user computing device 102 or external device 111) transmitting (block 321a) an input 322 to a data inbox 326. In certain instances, the computing device 321 may transmit the input 322 directly into the system (blocks 321b, 321c) because the input 322 is already formatted in a standardized format (e.g., 328a, 328b, 328c). The input 322 may generally be an email message including text and/or images, video, etc. and/or attachments (e.g., PDF documents), any of which may indicate project data associated with a project in an arbitrary, non-standardized format. The input 322 may be received at another computing device (e.g., user computing device 102) for direct upload (block 324) to the data inbox 326, and/or the input 322 may be routed directly via email 325 to the data inbox 326.

Once received, the data inbox 326 may enable/allow a processing service 327 to access/retrieve the input 322 and transmit the input 322 for storage (e.g., as raw input) and processing. Namely, the processing service 327 may transmit the input 322 to a data extraction and machine learning component 328 (e.g., utilizing external input analysis model 106d) that analyzes the input 322 to extract data and output predicted classifications and predicted impacts. Further, the data extraction and machine learning component 328 may determine a standardized format for the extracted data based on the predicted classifications, and may convert the extracted data from the arbitrary, non-standardized format of the raw input 322 to one of the standardized formats 328a, 328b, 328c.

For example, the first standardized format 328a may correspond to an invoices classification, the second standardized format 328b may correspond to a commitments classification, and the third standardized format 328c may correspond to a lien waivers classification. As part of the extraction and conversion, and as described herein, the data extraction and machine learning component 328 may only extract and convert data from the input 322 that is relevant to the predicted classification. It should be appreciated that the standardized formats 328a-c are illustrated in FIG. 3B as three distinct formats for the purposes of discussion only, and that there may be any suitable number of standardized formats.

As an example, the input 322 may be or include an updated commitment associated with a known contractor for a project. The data extraction and machine learning component 328 may analyze the updated commitment to determine that it relates to and updates certain values of a previous commitment for the known contractor, while also including several values/terms that are unchanged relative to the previous commitment. In this example, the data extraction and machine learning component 328 may compare the updated commitment terms/values with the previous commitment terms/values using OCR and/or other suitable text/image analysis techniques described herein to determine which terms/values represent updates to the commitment from the known contractor. The data extraction and machine learning component 328 may then extract the updated values and output a predicted classification corresponding to a commitment without extracting any of the unchanged values/terms. Accordingly, the data extraction and machine learning component 328 only extracts and consequently converts updated/new (i.e., non-redundant) data from received inputs.

In any event, as mentioned, the processing service 327 may transmit the input 322 for storage, which may include transmitting the input 322 to a database 329. Moreover, in certain scenarios, the processing service 327 may retrieve and transmit the standardized data to a computing device 332 (e.g., user computing device 102) for review by a user. In an example, the user may review the standardized data and request a report summarizing and/or otherwise indicating the standardized data and/or any other data that would be included as part of the requested report (e.g., additional data corresponding to a data category of the standardized data). The user's request may be received at a report generation engine 330, which may retrieve/access the standardized data and/or the raw input 322 to generate and output a report 333 for display/review at a computing device 334 (e.g., user computing device 102). In certain embodiments, the computing devices 321, 323, 332, and/or 334 may be an identical computing device.

In certain embodiments, each of the processing service 327, the data extraction and machine learning component 328, the database 329, and/or the report generation engine 330 may be or include cloud-based resources.

### Example Methods for Optimizing Data Storage

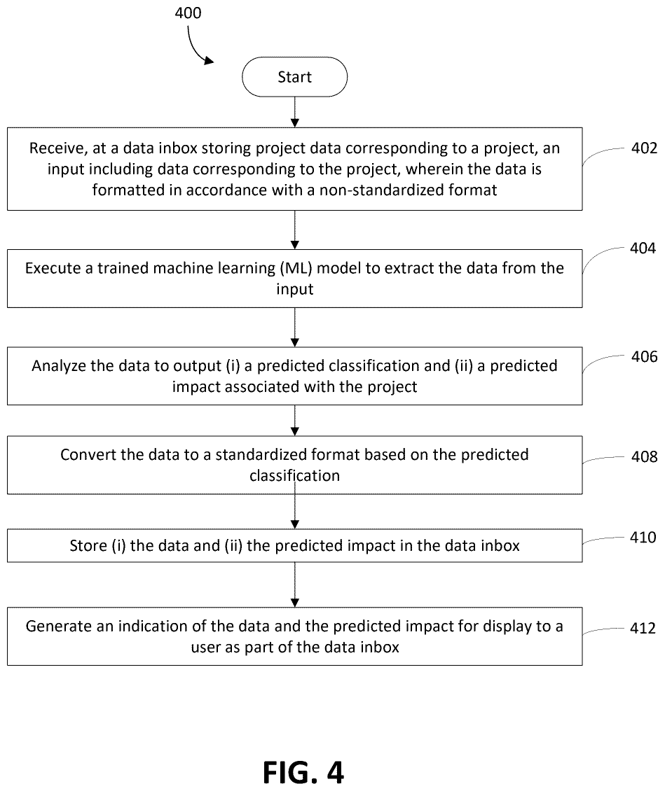

FIG. 4 illustrates an example method 400 for optimizing project data storage, in accordance with various embodiments described herein. At least portions of the method 400 may be performed by one or more processors (e.g., processor(s) 108, 113) utilizing the embodiments of the user computing device 102, the host server 104, and/or the remote server 105 of FIG. 1, for example, or by other suitable modules or systems. In embodiments, the method 400 may include additional or alternate steps other than those described herein.

At block 402, the example method 400 includes receiving, at a data inbox indicating project data corresponding to a project, an input including data corresponding to the project. The data is formatted in accordance with a non-standardized format. The method 400 further includes executing a trained machine learning (ML) model to: extract the data from the input (block 404). The method 400 further includes analyzing the data to output (i) a predicted classification and (ii) a predicted impact associated with the project (block 406).

The method 400 further includes converting the data to a standardized format based on the predicted classification (block 408). The method 400 further includes storing (i) the data and (ii) the predicted impact in a project database associated with the project (block 410). The method 400 further includes generating an indication of the data and the predicted impact for display to a user as part of the data inbox (block 412).

In some aspects, the trained ML model is trained using a plurality of training inputs and a plurality of training extracted data as input to output a plurality of training predicted classifications and a plurality of training predicted impacts.

In some aspects, the data included in the input is a subset of a plurality of data included in the input, and the method 400 further includes executing the trained ML model to: analyze the plurality of data included in the input to determine that a remainder of the plurality of data is redundant data that is stored as part of the project; and extract the subset from the input without extracting the remainder of the plurality of the data.

In some aspects, the project database includes a plurality of standardized data, and the method 400 further includes determining that a report threshold is exceeded based on the data included in the input; automatically generating a report associated with the project based on the data included in the input and at least a portion of the plurality of standardized data; and generating an indication of the report for display to the user as part of the data inbox.

In some aspects, the trained ML model utilizes at least one of: (i) optical character recognition (OCR), (ii) image recognition, (iii) object recognition, or (iv) image extrapolation.

In some aspects, the indication includes a reference link to the input.

In some aspects, the method 400 further includes transmitting a message for users connected to the data inbox in real-time indicating the data and the predicted impact. Further, in certain aspects, the data inbox accesses received inputs via a listener interface configured to automatically retrieve and process the received inputs in real-time.

In some aspects, the predicted classification indicates a data type associated with the data, and the predicted impact indicates one or more effects caused by the data to other data stored as part of the project.

In some aspects, the method 400 further includes converting the data to a standardized format by: determining one or more data input locations within a file associated with each individual data value from the data based on the data type indicated by the predicted classification, wherein the file is stored within a relational database; and inputting the individual data values into the one or more data input locations.

In some aspects, the method 400 further includes identifying an inconsistency within the data based on other data stored in association with the project; and generating an alert for transmission to an entity that transmitted the data to the data inbox indicating the inconsistency.

In some aspects, the trained ML model is a first trained ML model, and the method 400 further includes determining a first data category for the data included in the input; executing a second trained ML model to determine a predicted data category mapping for the first data category that maps the first data category to a normalized data category, wherein the trained ML model is trained using a plurality of training data categories and a plurality of training normalized data categories as input to output a plurality of training predicted data category mappings; executing, based on the predicted data category mapping, a nesting data module configured to: input the first data category into a first table having a first file size, and collapse the first table with a second table that includes a second data category that is related to the first data category to generate a nested table, wherein the second table has a second file size, and the nested table has a third file size that is less than a combination of the first file size and the second file size; and storing the nested table in the project database.

In some aspects, the input is a first input, the data is a first set of data, the non-standardized format is a first non-standardized format, the predicted classification is a first predicted classification, the predicted impact is a first predicted impact, the indication is a first indication, and the method 400 further includes, in parallel with the first input by utilizing parallel processing: receiving, at the data inbox, a second input including a second set of data corresponding to the project, wherein the second set of data is formatted in accordance with a second non-standardized format; executing, the trained ML model to: extract the second set of data from the second input, and analyze the second set of data to output (i) a second predicted classification and (ii) a second predicted impact associated with the project; converting the second set of data to the standardized format based on the second predicted classification; storing (i) the second set of data and (ii) the second predicted impact in the project database; and generating a second indication of the second set of data and the second predicted impact for display to the user as part of the data inbox.

### Example Graphical User Interfaces (GUIs)

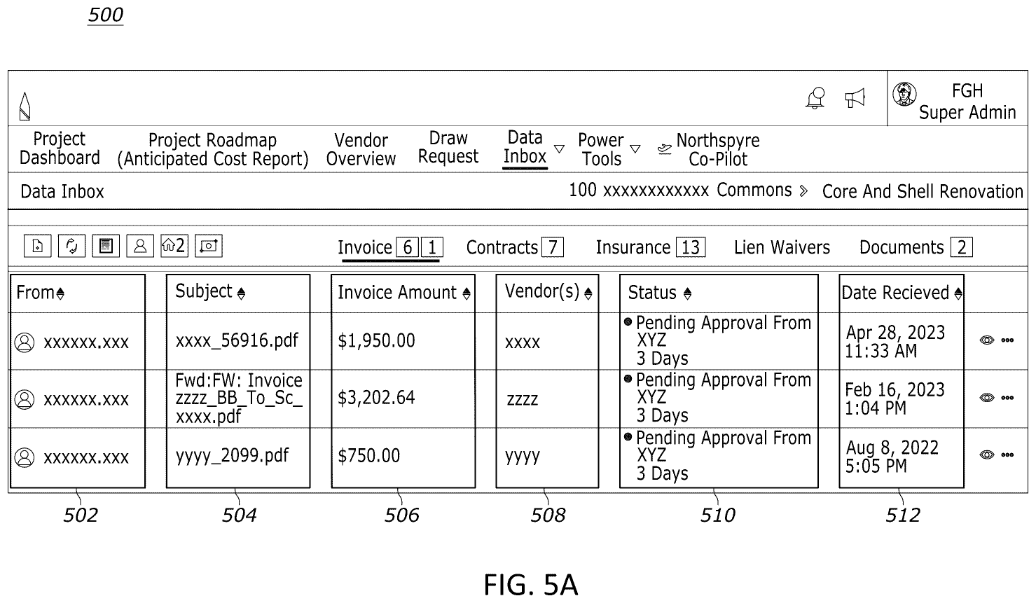

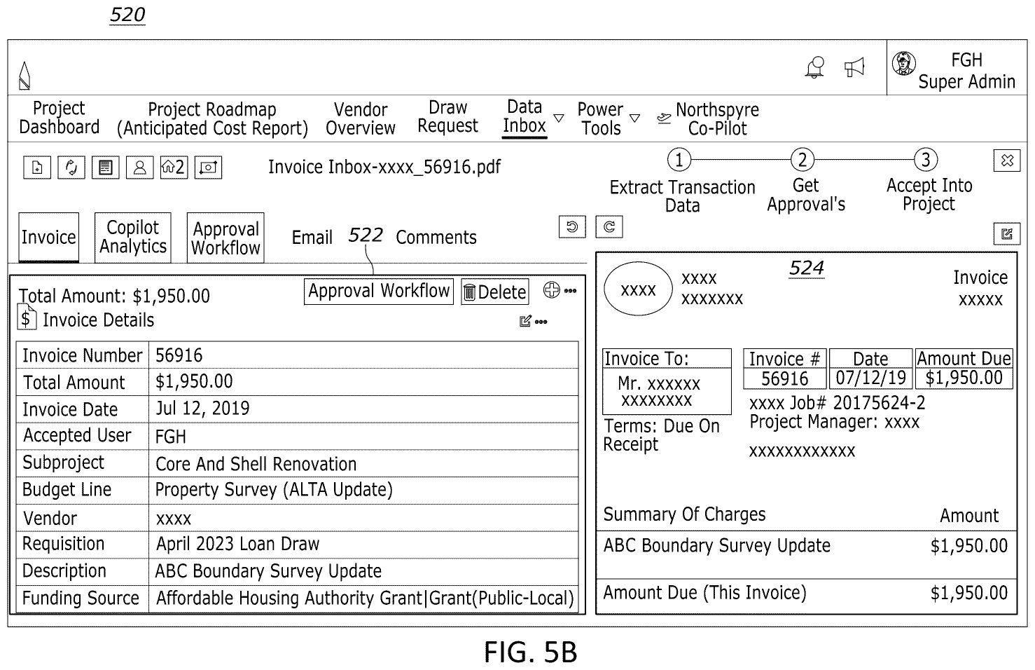

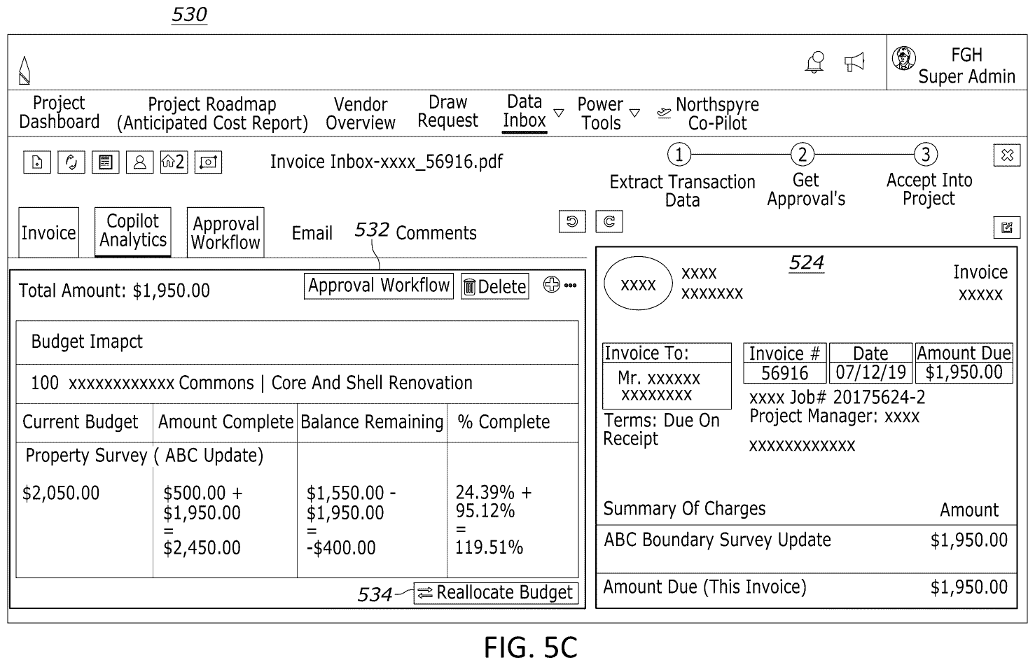

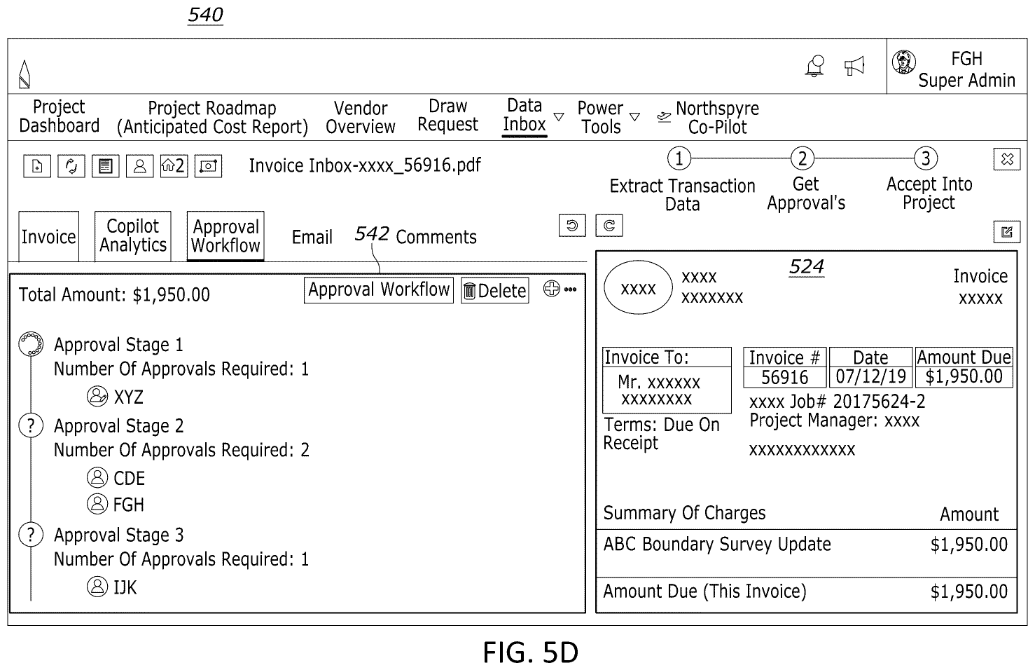

FIGS. 5A-5D depict example data inbox graphical user interfaces (GUIs), in accordance with various embodiments described herein. Generally, each of the GUIs referenced herein in FIGS. 5A-5D represent various functional aspects of the data inbox (e.g., data inbox 106i) and corresponding components (e.g., external input analysis model 106d, data inbox application 106g, standardization instructions 106h, etc.), as described herein.

For example, the example GUI 500 of FIG. 5A illustrates an example data inbox interface that includes multiple display portions 502-512 featuring data extracted from an input by, e.g., the external input analysis model 106d when executed by the data inbox application 106g. The first display portion 502 includes sender addresses indicating from where/who the data inbox received the remaining data displayed in the display portions 504-512. As illustrated in FIG. 5A, these sender addresses may be email addresses, but it should be appreciated that the sender addresses may include any suitable information (e.g., physical address “123 Main Street”) related to the originating location of the received project data.

The second display portion 504 includes a brief description of the message subject. As illustrated in the example GUI 500, the message subject may include a summarized indication (e.g., “Fwd:FW: Invoice”) of the message content, an attachment and/or reference link to a document (e.g., “xxxx_56916.pdf”), and/or any other suitable indication of the message content. The third display portion 506 includes project data extracted from the original input. For example, each received message in the example GUI 500 may include an invoice with a corresponding invoice/cost value (e.g., “$1,950.00”, “$3,202.64”, and “$750.00”). The external input analysis model 106d may extract these invoice/cost values from the invoice so they may be displayed in the example GUI 500 in the third display portion 506.

The fourth display portion 508 includes identifying information of a sender/vendor associated with the received project data in the message. This data may be known (i.e., stored in the project database 106e) at the time of message receipt, such that the external input analysis model 106d may not need to extract and/or classify this data. This distinction may be visually indicated in the fourth display portion 508, with new (i.e., extracted and classified) data receiving a distinct visual characteristic (e.g., different color, pattern, etc.) from other, known data. For example, the senders/vendors “xxxx” and “yyyy” may be stored in the project database prior to receipt of the messages displayed in the example GUI 500, but the sender/vendor “zzzz” may be new to the project. Thus, the data inbox application 106g may display the “zzzz” with a distinct visual characteristic to indicate their initial appearance as part of the project.

The fifth display portion 510 represents a current status of the project data. The current status may generally correspond to a next step and/or approval required to approve, store, update, and/or otherwise process the project data referenced by the associated message. For example, the statuses included in the fifth display portion 510 each indicate that a next step is “Pending Approval From XYZ” with an indication that this next step has been pending for 3 days. Thus, any user accessing the data inbox can view these next steps and notify user “XYZ” that their approval is required to fully process the invoices, commitments, lien waivers, and/or other project data indicated by the messages in the data inbox. The sixth display portion 512 indicates dates/times of receipt for each of the message in the data inbox.

In certain embodiments, a user may interact with one or more of the display portions 502-512 to access different GUIs and corresponding functions. For example, a user may interact with the second display portion 504 to transition from the example GUI 500 to the example GUI 520 of FIG. 5B. This example GUI 520 generally displays the extracted data 522 along with the original input 524 to enable quick and accurate access to the relevant information from the original input 524.

For example, the original input 524 is an invoice received from “xxxx”. The invoice includes a summary of charges with a corresponding service description and amount, an amount due, an invoice number, a date, a recipient address, and a header with a sender address, document title, and company logo. The data inbox application 106g may execute the external input analysis model 106d to analyze this invoice and extract/classify some/all of this data included therein, and the application 106g may convert the data to a standardized format for display as part of the extracted data 522. In particular, the model 106d may analyze and extract/classify data such as the invoice number, total amount due, invoice date, service description (i.e., “ABC Boundary Survey Update”) directly from the invoice.

The data inbox application 106g may also include additional data in the extracted data 522 from the project database 106e that was not included in the invoice. For example, the application 106g may include an accepted user, subproject, data category (e.g., “budget line”), vendor, requisition, and/or funding source, which was not included and/or extracted from the invoice. Thus, the data inbox application 106g may retrieve relevant project data from the project database 106e to supplement the extracted data based on the assigned classifications and/or data categories of the extracted data to provide the user with a more holistic and informative description related to the invoice.

As described herein, in certain instances, the data inbox application 106g determines that extracted, classified, and standardized project data creates an inconsistency and/or otherwise violates a threshold associated with the project. The example GUI 530 illustrates an example analytics interface depicting an example scenario in which project data extracted from a received invoice violates a threshold associated with a project. Namely, the invoice amount (“$1,950.00), when combined with the other budget allocations for the particular data category (e.g., “Property Survey (ABC update)”), exceeds the total budgeted amount for the particular data category. This is illustrated in the predicted impact section 532 adjacent to the original input 524.

More specifically, the data inbox application 106g (e.g., via the external input analysis model 106d) compares the extracted invoice amount combined with the other allocations associated with the data category to a total budgeted amount (e.g., a data category budget threshold) to determine the combination exceeds the total budgeted amount. In response to determining that the data category budget threshold is violated, the data input analysis model 106d may output a predicted impact indicating the violation and may further provide a recommended solution. For example, the model 106d may analyze other data categories to identify budget surpluses, projected surpluses, funds in reserve, and/or other similar values that may contribute to eliminating the violation.

Additionally, or alternatively, the model 106d may identify a likely error in the invoice (e.g., misplaced decimal point) by comparing the invoiced amount to the projected/expected amount for the indicated data category or sub-service. As another example, the external input analysis model 106d may analyze the percentage completion value corresponding to the data category and determine that the combined percentage completion value of all data entries represents a 119.5% completion value, which is clearly erroneous. Accordingly, the model 106d may output a predicted impact indicating that the invoice likely includes incorrect information and should be adjusted to bring the combined percentage completion value down from 119.5% to 100% or less.

The data inbox application 106g may display this information in the predicted impact section 532, and may also provide an interactive button 534 that, when a user interacts (e.g., clicks, taps, swipes, gestures, voice commands) with the button 534, causes the application 106g to automatically adjust values in the project database 106e, in accordance with the recommended solution output by the external input analysis model 106d. For example, a user may interact with the interactive button 534, and the application 106g may automatically reallocate portions of the budget associated with a project to alleviate and/or eliminate the excess allocation (e.g., increase the budget) to the data category indicated in the original input 524.

As mentioned, the data inbox may include information relating to next steps, such as approvals required to continue processing or storing the project data. The example GUI 540 of FIG. 5D illustrates an example approval workflow 542 corresponding to the original input 524. Generally, the example approval workflow 542 is generated by the data inbox application 106g based on data retrieved from the project database 106e and indicates sequences and/or workflows through which extracted project data is approved for entry/storage in the project database 106c.

The example approval workflow 542 of FIG. 5D includes three approval stages, each of which includes one or more approvals. For example, the first approval stage requires a single approval from “XYZ”, the second approval stage requires an approval from both “CDE” and “FGH”, and the third approval stage requires a single approval from “IJK”. The data in box application 106g may actively (i.e., in real-time) update each of the graphical indicators rendered as part of the example approval workflow 542 in response to the indicated user(s) providing approval and/or any other required response.

For example, at the first approval stage, user “XYZ” may review the original input 524 and/or any extracted project data therefrom (e.g., represented in example GUIs 500, 520, 530) and may approve the invoice. In response to receiving user “XYZ”'s approval, the data inbox application 106g may update the graphical indicator next to the “Approval Stage 1” and/or the name “XYZ” to a check mark, a different color/pattern, and/or any other suitable graphical indication(s). Further, the data in box application 106g may transmit an update to user “CDE” and user “FGH” in real-time indicating that user “XYZ” has approved the invoice, and that they are now responsible for reviewing/approving the invoice. This message may be an email message and/or may utilize any suitable communication media (e.g., text message, social media direct message, phone call, linked personal email address, communication platform message (e.g., Zoom, Slack, etc.)).

At the second approval stage, user “CDE” may approve the invoice quickly, and as a result, the data inbox application 106g may update the graphical indicator adjacent to user “CDE”'s name to indicate a completed approval, update the graphical indicator adjacent to “Approval Stage 2” to an intermediate graphic indicating some (but not all) approvers have approved the invoice, and may leave user “FGH”'s graphical indicator unchanged. When user “FGH” completes their review and approves the invoice, the data inbox application 106g may update the graphical indicator adjacent to “Approval Stage 2” to a completed graphic indicating all approvers have approved the invoice, and may update user “FGH”'s graphical indicator to indicate a completed approval.

At the third approval stage, user “IJK” may reject (i.e., not approve) the invoice. In response, the data inbox application 106g may transmit another message to all indicated approvers (e.g., user “XYZ”, user “CDE”, and user “FGH”) indicating user “IJK”'s rejection, and may update user “IJK”'s graphical indicator (and the indicator adjacent to the “Approval Stage 3”) to indicate a rejection of the invoice. The message may include an indication related to why user “IJK” rejected the invoice and may request that some/all of the approvers re-evaluate the invoice to confirm or deny user “IJK”'s rejection. If the approvers confirm user “IJK”'s rejection, the data inbox application 106g may automatically transmit a message to the sending entity (e.g., “xxxx”) indicating that the invoice was rejected along with the reason provided by the approvers and/or by the data inbox application 106g. In certain embodiments, the data inbox application 106g may generate and transmit the message to the sending entity in response to user “IJK”'s rejection of the invoice.

### Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although user operations of one or more methods are illustrated and described as separate operations, one or more of the user operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A system for optimizing project data storage comprising:
one or more processors; and
one or more memories communicatively coupled with the one or more processors,
the one or more memories storing a trained machine learning (ML) model, a data inbox, a project database associated with a project, and computer executable instructions that, when executed by the one or more processors, cause the one or more processors to:
receive, at the data inbox, an input including data corresponding to the project, wherein the data is formatted in accordance with a non-standardized format;
access the received input via a listener interface configured to automatically retrieve and process the received input in real-time;
execute the trained ML model to:
extract the data from the input, and
analyze the data to output (i) a predicted classification and (ii) a predicted impact associated with the project;
convert the data to a standardized format based on the predicted classification by:
determining one or more data input locations within a file associated with each individual data value from the data based on a data type indicated by the predicted classification, wherein the file is stored within a relational database, and
inputting the individual data values into the one or more data input locations:
store (i) the data and (ii) the predicted impact in the project database; and
generate an indication of the data and the predicted impact for display to a user as part of the data inbox.

2. The system of claim 1, wherein the trained ML model is trained using a plurality of training inputs and a plurality of training extracted data as input to output a plurality of training predicted classifications and a plurality of training predicted impacts.

3. The system of claim 2, wherein the data included in the input is a subset of a plurality of data included in the input, and the computer executable instructions, when executed by the one or more processors, cause the one or more processors to execute the trained ML model to:
analyze the plurality of data included in the input to determine that a remainder of the plurality of data is redundant data that is stored as part of the project; and
extract the subset from the input without extracting the remainder of the plurality of the data.

4. The system of claim 1, wherein the project database includes a plurality of standardized data, and the computer executable instructions, when executed by the one or more processors, further cause the one or more processors to:
determine that a report threshold is exceeded based on the data included in the input;
automatically generate a report associated with the project based on the data included in the input and at least a portion of the plurality of standardized data; and
generate an indication of the report for display to the user as part of the data inbox.

5. The system of claim 1, wherein the trained ML model utilizes at least one of: (i) optical character recognition (OCR), (ii) image recognition, (iii) object recognition, or (iv) image extrapolation.

6. The system of claim 1, wherein the indication includes a reference link to the input.

7. The system of claim 1, wherein the computer executable instructions, when executed by the one or more processors, further cause the one or more processors to:
transmit a message for users connected to the data inbox in real-time indicating the data and the predicted impact.

8. The system of claim 1, wherein the predicted classification indicates a data type associated with the data, and the predicted impact indicates one or more effects caused by the data to other data stored as part of the project.

9. (canceled)

10. The system of claim 1, wherein the computer executable instructions, when executed by the one or more processors, further cause the one or more processors to:
identify an inconsistency within the data based on other data stored in association with the project; and
generate an alert for transmission to an entity that transmitted the data to the data inbox indicating the inconsistency.

11. The system of claim 1, wherein the trained ML model is a first trained ML model, and the computer executable instructions, when executed by the one or more processors, further cause the one or more processors to:
determine a first data category for the data included in the input;
execute a second trained ML model to determine a predicted data category mapping for the first data category that maps the first data category to a normalized data category, wherein the trained ML model is trained using a plurality of training data categories and a plurality of training normalized data categories as input to output a plurality of training predicted data category mappings;
execute, based on the predicted data category mapping, a nesting data module configured to:
input the first data category into a first table having a first file size, and
collapse the first table with a second table that includes a second data category that is related to the first data category to generate a nested table, wherein the second table has a second file size, and the nested table has a third file size that is less than a combination of the first file size and the second file size; and
store the nested table in the project database.

12. The system of claim 1, wherein the input is a first input, the data is a first set of data, the non-standardized format is a first non-standardized format, the predicted classification is a first predicted classification, the predicted impact is a first predicted impact, the indication is a first indication, and the computer executable instructions, when executed by the one or more processors, further cause the one or more processors to, in parallel with the first input by utilizing parallel processing:
receive, at the data inbox, a second input including a second set of data corresponding to the project, wherein the second set of data is formatted in accordance with a second non-standardized format;
execute, the trained ML model to:
extract the second set of data from the second input, and
analyze the second set of data to output (i) a second predicted classification and (ii) a second predicted impact associated with the project;
convert the second set of data to the standardized format based on the second predicted classification;
store (i) the second set of data and (ii) the second predicted impact in the project database; and
generate a second indication of the second set of data and the second predicted impact for display to the user as part of the data inbox.

13. (canceled)

14. A computer-implemented method for optimizing project data storage comprising:
receiving, at a data inbox indicating project data corresponding to a project, an input including data corresponding to the project, wherein the data is formatted in accordance with a non-standardized format;
accessing the received input via a listener interface configured to automatically retrieve and process the received input in real-time;
executing, by one or more processors, a trained machine learning (ML) model to:
extract the data from the input, and
analyze the data to output (i) a predicted classification and (ii) a predicted impact associated with the project;
converting, by the one or more processors, the data to a standardized format based on the predicted classification by:
determining one or more data input locations within a file associated with each individual data value from the data based on a data type indicated by the predicted classification, wherein the file is stored within a relational database, and
inputting the individual data values into the one or more data input locations;
storing, by the one or more processors, (i) the data and (ii) the predicted impact in a project database associated with the project; and
generating, by the one or more processors, an indication of the data and the predicted impact for display to a user as part of the data inbox.

15. The computer-implemented method of claim 14, wherein the trained ML model is trained using a plurality of training inputs and a plurality of training extracted data as input to output a plurality of training predicted classifications and a plurality of training predicted impacts.

16. The computer-implemented method of claim 15, wherein the data included in the input is a subset of a plurality of data included in the input, and the method comprises executing the trained ML model to:
analyze the plurality of data included in the input to determine that a remainder of the plurality of data is redundant data that is stored as part of the project; and
extract the subset from the input without extracting the remainder of the plurality of the data.

17. The computer-implemented method of claim 14, wherein the project database includes a plurality of standardized data, and the method further comprises:
determining, by the one or more processors, that a report threshold is exceeded based on the data included in the input;
automatically generating, by the one or more processors, a report associated with the project based on the data included in the input and at least a portion of the plurality of standardized data; and
generating, by the one or more processors, an indication of the report for display to the user as part of the data inbox.

18. The computer-implemented method of claim 14, wherein the predicted classification indicates a data type associated with the data, and the predicted impact indicates one or more effects caused by the data to other data stored as part of the project.

19. (canceled)

20. A non-transitory tangible machine-readable medium comprising instructions that, when executed, cause a machine to at least:
receive, at a data inbox indicating project data corresponding to a project, an input including data corresponding to the project, wherein the data is formatted in accordance with a non-standardized format;
access the received input via a listener interface configured to automatically retrieve and process the received input in real-time;
execute a trained machine learning (ML) model to:
extract the data from the input, and
analyze the data to output (i) a predicted classification and (ii) a predicted impact associated with the project;
convert the data to a standardized format based on the predicted classification by:
determining one or more data input locations within a file associated with each individual data value from the data based on a data type indicated by the predicted classification, wherein the file is stored within a relational database, and
inputting the individual data values into the one or more data input locations;
store (i) the data and (ii) the predicted impact in a project database associated with the project; and
generate an indication of the data and the predicted impact for display to a user as part of the data inbox.
